(19) United States
(12) Patent Application Publication
(10) Pub. No.: US 2015/0058392 A1
(43) Pub. Date: Feb. 26, 2015

(54) PROVISIONING CHAIN QUEUING AND PROCESSING

(71) Applicant: Cellco Partnership d/b/a Verizon Wireless, Basking Ridge, NJ (US)

(72) Inventor: Elena KRIMCHANSKY, New City, NY (US)

(73) Assignee: Cellco Partnership d/b/a Verizon Wireless, Basking Ridge, NJ (US)

(21) Appl. No.: 13/971,424

(22) Filed: Aug. 20, 2013

(51) Int. Cl. H04L 29/08

(52) U.S. Cl. CPC H04L 67/10
USPC 709/201

(57) ABSTRACT

A system for and method of provisioning chain queuing and processing. Chain queuing and processing defines and supports ordered provisioning of requests to be sent to network elements that either contain information on behalf of one another or are for a network activity that requires the presence of a properly provisioned record to perform an action. In contrast to conditional queuing that determines a provisioning need at the time of transaction execution, chain queuing may include a complex execution plan determined at the time of queuing based on a plurality of processing and dispatching rules. These rules may be based on a concept of one provisioning request being a prerequisite for at least one subsequent event. In other words, a parent-child relationship may exist between two or more resulting transactions derived from one request. These parent-child relationships may then be incorporated into dispatching, queuing, and processing rules to create a fully detailed execution plan.

### BACKGROUND INFORMATION

Ordered transactions in queues where transactions have mutual dependencies and/or are contingent upon each other may contribute to complications and unpredictable results. Additionally, these mutual dependencies and contingencies may make it very difficult to achieve accurate and predictable processing outcomes. Current examples of algorithms used in processing of queued transactions include autonomous queuing and conditional queuing. For example, autonomous queuing and processing may be used to queue up transactions based on queuing rules defined by reference data, process them independently of each other, and forward responses to request originators as they become available. Accordingly, autonomous queuing and processing may be inapplicable in situations where precedence and mutual dependencies of subscriber provisioning are required. Moreover, autonomous queuing does not provide a comprehensive view of a request having multiple transactions and their relationships since each transaction is created and intended to be processed independently of one another.

Conditional queuing and processing may be employed when a sequential order of provisioning must be adhered to in order to accommodate dependencies of transactions in a queue. Conditional queuing and processing supports limited internal dependencies of transactions associated with various network elements. In conditional queuing and processing, the successful provisioning of a transaction at one network element can trigger a subsequent transaction to be queued at another network element. However, conditional queuing and processing does not allow all transactions associated with a request to be queued at the same time. Instead, each conditional subsequent transaction is queued in response to a successful processing result of a parent transaction as part of its execution. These and other drawbacks exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a chain queuing and processing system according to a particular embodiment;

FIG. 2 is a block diagram of hardware components of a chain queuing and processing system of a particular embodiment;

FIG. 3 is a flowchart illustrating chain queuing and processing according to a particular embodiment;

FIG. 4 is a flow diagram illustrating chain queuing and processing according to an exemplary embodiment;

FIG. 5 is a flow diagram illustrating chain queuing and processing according to an exemplary embodiment.

### DETAILED DESCRIPTION OF PREFERRED EMBODIMENTS

A system and method may include various exemplary embodiments for chain queuing and processing. Chain queuing and processing defines and supports ordered provisioning of transactions associated with at least one request. Chain queuing and processing may allow all transactions associated with a request to be queued for processing at respective network elements. Chain queuing and processing may also allow transactions to be flagged as dependent on one another, for example in a parent-child relationship, and then queued at a network element with an associated flag, which defines the states of execution readiness. In contrast to conditional queuing, chain queuing and processing may include a complex execution plan determined at the time of queuing based on a plurality of rules. These rules may be based on a concept of one provisioning request being a prerequisite for at least one subsequent event. In other words, a parent-child relationship may exist between two or more transactions that are specified in a single request, where each transaction is destined for a particular network element component that provides provisioning to support services requiring provisioning. These parent-child relationships may then be incorporated into queuing rules.

A system and method for chain queuing and processing may include a requesting device that may originate a request for service provisioning, where each request may result in multiple transactions. The request may then be sent over a network to a Chain Queuing and Processing System (“ChainQP”) where the request may be transformed into various transactions. Each transaction of the request may be dispatched to a queue associated with a network element assigned to process the transaction. The dispatching process may be based on dispatching rules that determine a control flag to set for each transaction of the request. A control flag may include an indicator that associates the transaction with an execution readiness state indicating whether or not to process a particular transaction at a network element at any given time. Once a network element is available to process a transaction and the control flag indicates that the transaction may be processed, the network element may process the transaction.

The response from the network element pertaining to the outcome of the processed transaction may then be sent to the ChainQP system, where it may then be evaluated based on the success or failure of the outcome. When the ChainQP system evaluates a transaction success outcome, the remaining successive transaction(s) may be “unlocked” by setting a control flag to a READY state so that they can be processed at each transaction's respective network element. When the ChainQP system evaluates a failure status, the remaining successive transaction(s) may also be updated with a FAILED_PARENT status and removed from their respective queues. The ChainQP system may then send a completion status to the originator of the request, which may be a success or a failure. The ChainQP system may also generate, record, and/or transmit a summary, which may include a listing of transactions and their respective completion statuses, thereby illustrating all transactions associated with the request and their respective statuses. Additional method and system components are described below.

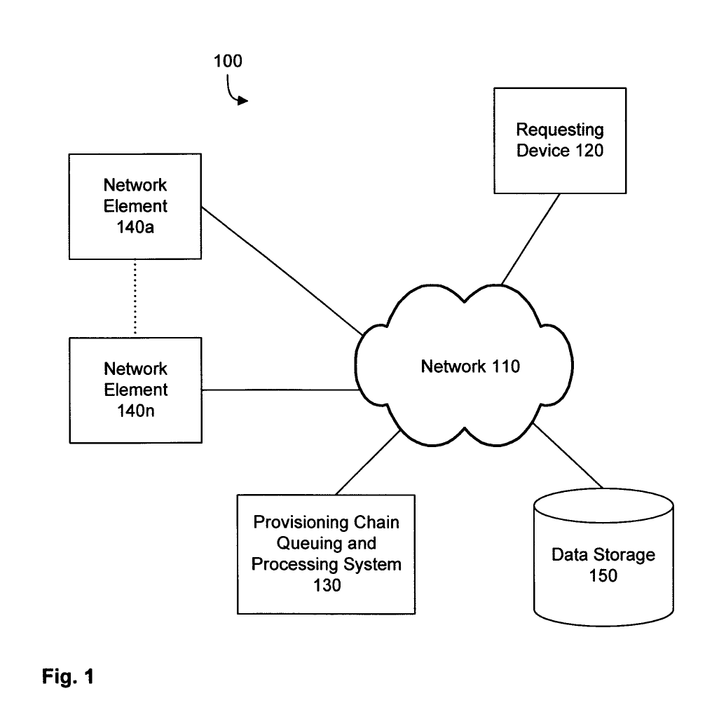

FIG. 1 illustrates a schematic diagram illustrating a chain queuing and processing system 100 according to a particular embodiment. System 100 includes a requesting device 120, a provisioning chain queuing and processing system (“ChainQP”) 130, a plurality of network elements 140a-140n, and data storage 150 all connected over a network 110.

Although various elements of the system 100 may be described as a single device, it will be appreciated that multiple instances of these devices may be included in the system 100, such as, for example, multiple requesting devices 120, ChainQP systems 130, and/or data storage 150.

Network 110 may be a wireless network, a wired network or any combination of wireless network and wired network. For example, network 110 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 110 may include, without limitation, telephone line, fiber optics, IEEE Ethernet 802.3, a wide area network (“WAN”), a local area network (“LAN”), or a global network such as the Internet. Also, network 110 may support, an Internet network, a wireless communication network, a cellular network, or the like, or any combination thereof. Network 110 may further include one, or any number of the exemplary types of networks mentioned above operating as a stand-alone network or in cooperation with each other. Network 110 may utilize one or more protocols of one or more network elements to which it is communicatively coupled. Network 110 may translate to or from other protocols to one or more protocols of network devices. Although network 110 is depicted as one network, it should be appreciated that according to one or more embodiments, network 110 may comprise a plurality of interconnected networks, such as, for example, a service provider network, the Internet, a broadcaster's network, a cable television network, corporate networks, and home networks.

Each network element 140, ChainQP system 130, and requesting device 120 may include, for example, a processing device, a bus, a memory, a storage device, an input device, an output device, and/or a communication interface. Each network element 140, ChainQP system 130, and requesting device 120 may also include a router, a switch, and/or a gateway. Furthermore, each network element 140, ChainQP system 130, and requesting device 120 may include a plurality of modules to assist in a method of provisioning chain queuing and processing.

As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

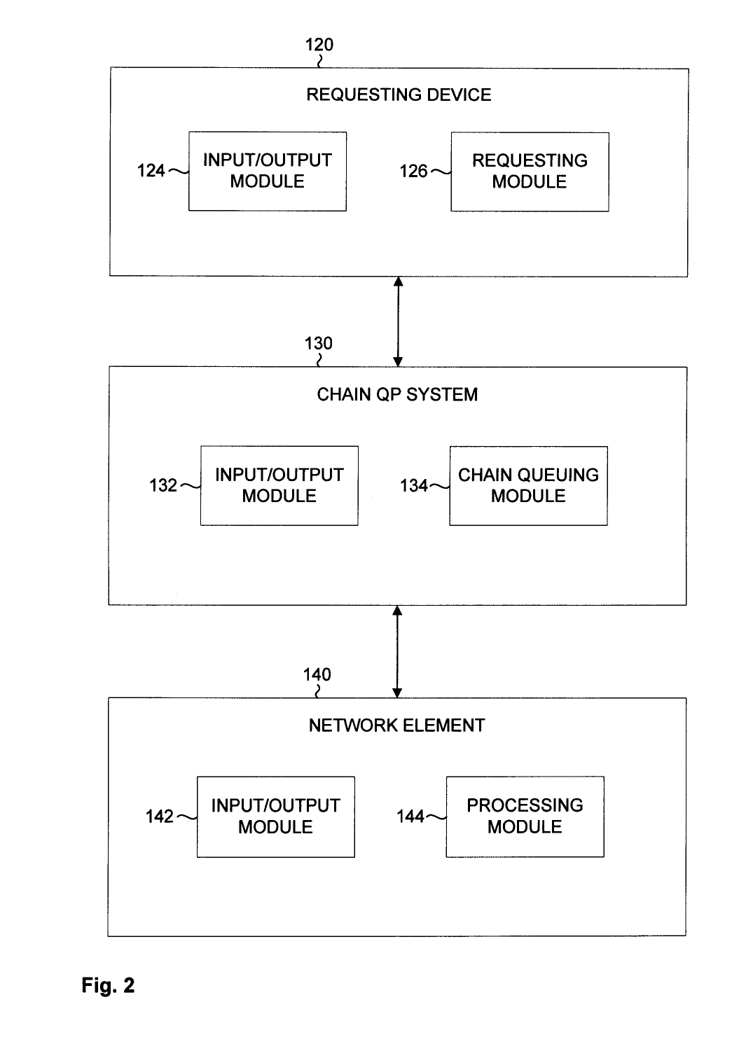

For example, FIG. 2 illustrates a block diagram of hardware components of a chain queuing and processing system of a particular embodiment. In particular, a requesting device 120 may include an input/output module 124 to enable the sending and receiving of data between the requesting device and either a ChainQP system 130 or a customer device, such as a computer, mobile device, television, or other device. A requesting device 120 may also include a requesting module 126 to facilitate extracting the required data to formulate a request to be sent to a ChainQP system.

ChainQP system 130 may include an input/output module 132 to enable the sending and receiving of data to and from the requesting device 120 and at least one network element 140. For example, the input/output module may facilitate at least the receipt of a request from the requesting device 120, the sending of at least one transaction associated with a request to a queue associated with a network element 140, the receipt of transaction processing responses from the network element 140, and the sending of a completion status to a requesting device 120. ChainQP system 130 may also contain a chain queuing module to facilitate the generating of queue entries of transactions and the processing of transaction responses received from the network element 140. As discussed below, the processing of requests to generate transactions to then be processed at a network element may be based on at least one ChainQP processing and/or dispatching rule.

ChainQP processing rules may include rules to ensure that, for example, only one transaction for any given request can be processed on a networking element to avoid any race conditions and inconsistencies and/or a request originator can send only one request for a given customer. ChainQP dispatching rules may include: determining a transaction type associated with at least one transaction of a request, where transaction types may include add, change, delete, or amend; determining at least one provisionable service specified in the request, such as for example, short messaging, video calling, cloud computing, voice mail servicing, loading specified software over the air, or any other provisionable service; determining an originator of the request; determining one or more destinations for processing the one or more transactions of the request, where the one or more destinations may be based on network elements assigned to a customer, service provider, mobile-block identifier (MBI) range, and/or device being provisioned; and determining a priority associated with the request origin, such as which customer the request is associated with or what system the request originated at, such as for example, a billing system, a self-service system, a customer service system, or a troubleshooting system. An MBI range may include geographical range associated with a customer. For example, an MBI range may be based on a country, state, county, city, street address, and/or zip code associated with the to-be provisioned device.

In addition, the ChainQP dispatching rules may include control flag rules to process interdependencies, expressed as parent-child relationships. Control flag rules may include: setting a control flag as READY if there are no previously queued transactions for the same identity to a specific network element 140; setting a control flag to WAITING if there is at least one previously queued transaction for a specific network element 140 for the same identity; and setting a control flag to PWAITING if there is at least one previously queued transaction for an identity at for a specific network element 140 and the transaction has a parent transaction that has not yet been processed. As a result of applying the ChainQP processing and/or dispatching rules, one or more transactions may be queued to one or more network elements, where only one transaction per network element for a given customer is in READY state. Generating queue entries of transaction may be based on dispatch rules that reflect transaction contingencies and mutual dependencies. The queues of the system 100 may be persistent database entities, enabling the storing of the events or transactions in a log and/or storage of updated portions as updates are made.

Network element 140 may include an input/output module 142 to enable the sending and receiving of data to and from a ChainQP system 130. For example, the input/output module 142 may facilitate at least the receipt of a transaction to be processed at the network element 140 and the transmission of a processing response. Network element 140 may also contain a processing module 144 that may process the transactions in queue according to at least one network element processing rule. Network element processing rules may be based on a priority and a control flag value of each transaction in a network element queue.

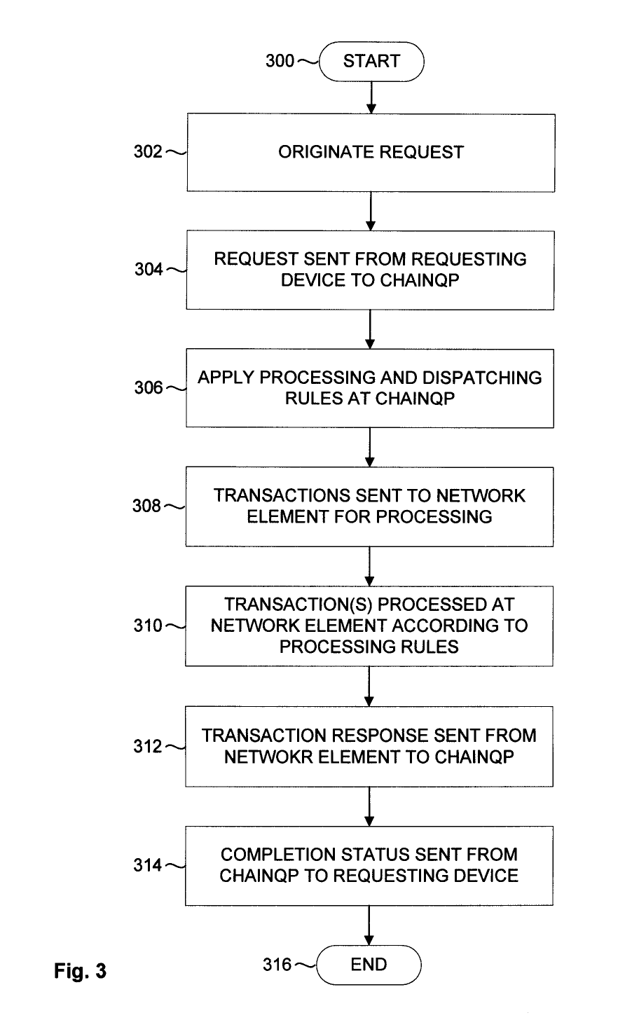

FIG. 3 illustrates a flowchart for chain queuing and processing according to a particular embodiment. The chain queuing and processing may begin at step 300. At step 302, a request is originated from the requesting module 126. The request may come from a requesting device 120 on behalf of a customer device, such as a mobile device, a computer, a television, or the like, and may include, for example, a request for services at the customer device or provisioning of a customer device. By way of example, the request may come from a requesting device 120 associated with a billing system on behalf of a mobile device, a support system associated with the mobile device, an online application associated with the device, and/or a technical support system associated with the device.

At step 304, a request may be sent from a requesting device 120 to a ChainQP system 130 via a network 110. Upon receipt, at step 306, the ChainQP system may begin executing the request according to the ChainQP dispatching rules. ChainQP processing rules may include rules to ensure that, for example, only one request for any given customer can be processed on a networking element to avoid any race conditions and unpredictable results. By way of example race conditions may exist where a customer device generates multiple requests, such as, for example, changing a voicemail feature, upgrading network capabilities, and altering data stored on a Subscriber Identity Module (“SIM”) card of the customer device. Accordingly, where all three requests are processed simultaneously, should, for example, the data on the SIM card be altered first, the request for changing of the voicemail feature, for example, may not be able to be properly executed since it may be based off of the data stored on the SIM card prior to its alteration. Accordingly, processing one request at a time may ensure that each request is properly executed. For example, should the request to alter SIM card data first be processed, the request to change a voicemail feature maybe processed based off of the newly altered SIM card data. Control flags may be used to ensure proper processing as described herein

ChainQP processing and dispatching rules may also include rules to generate an execution plane described by a splitlist. Splitlists may indicate how many transactions were generated as a result of the request and what network elements 140 each request transaction is queued to for processing. The splitlist may also represent all the network elements that need to and/or are provisioned for a particular request. Using a splitlist may allow the ChainQP system 130 to express an explicit execution plan that may subsequently be used in processing the results by the request originator by cross-referencing responses with the splitlist.

Additionally, ChainQP dispatching rules in the chain queuing module 134 may result in at least one transaction to be dispatched based on the request and how to place that transaction into a network element queue. Dispatching rules may ensure that all transactions associated with a request are queued. As discussed above, dispatching rules may include control flag rules and priority rules. Control flag rules may include: setting a control flag as READY if there are no previously queued transactions for a specific network element 140 and no parent transactions; setting a control flag to WAITING if there is at least one previously queued transaction for a specific network element 140; and setting a control flag to PWAITING if there is at least one previously queued transaction for a specific network element 140 and the transaction has a parent transaction that has not yet been processed. Dispatching rules may further include prioritizing requests as discussed above based on attributes of the request.

Accordingly, based on the dispatching rules, an execution plan may be created including a splitlist, and a listing of transactions with associated control flags and/or priority levels. The execution plan may ensure that all transactions generated from a request are processed according to a predictable plan. Additionally, the execution plan may ensure that, should a request fail for any reason, the execution outcome may indicate which transaction failed and any child transactions that remain unprocessed as a result of the originally failed parent transaction.

At step 308, once the request has been processed and transactions for the request have been dispatched according to a determined network element queuing in the chain queuing module 134, the transactions may be sent to each transaction's respective network element for processing. At step 310, a network element 140 may process a transaction according to network element processing rules in the processing module 144. Network element processing rules may include processing the next transaction in the network element queue with a control flag set to READY. Upon processing, a network element processing rule may determine that the transaction processing was either a success or failure.

If the processing of a transaction was a success, the processing module 144 may determine if any child transactions of the successfully completed transaction are queued. If no child transactions are queued, the processing module 144 may promote the next queue record and changing the control flag of that transaction from WAITING to READY. Where a child transaction is queued, the network element processing module 144 of the network element 140 may change the control flag of the child transaction from PWAITING to READY as well as promote the next queue record and change the control flag of the next queue record from WAITING to READY.

If the processing of a transaction was a failure, the processing module may then determine whether any child transactions relate to the failed parent transaction. If there are no child transactions, a failed response may be set for the transaction. If a child transaction exists, the processing module may set a failed status for the transaction, remove all of the queued child transactions from queues, and set all child transaction results to a FAILED_PARENT status.

Upon completion of the processing, the processed transaction may be deleted from the queue and a status for the transaction may be updated based on the network element processing outcome. At step 312, the processing response may be sent from the network element 140 to the ChainQP system 130. At step 314, a completion status may be sent from the ChainQP system 130 to the requesting device 120. Once a completion status has been sent to the requesting device, the processing at the network elements may continue where there are successive transactions left to process for the request. The process may repeat steps 310 through 312 until all transactions associated with a request have been processed or until a failure is detected. Once all transactions are successfully processed and/or a failure is detected the procedure 300 may end at step 316.

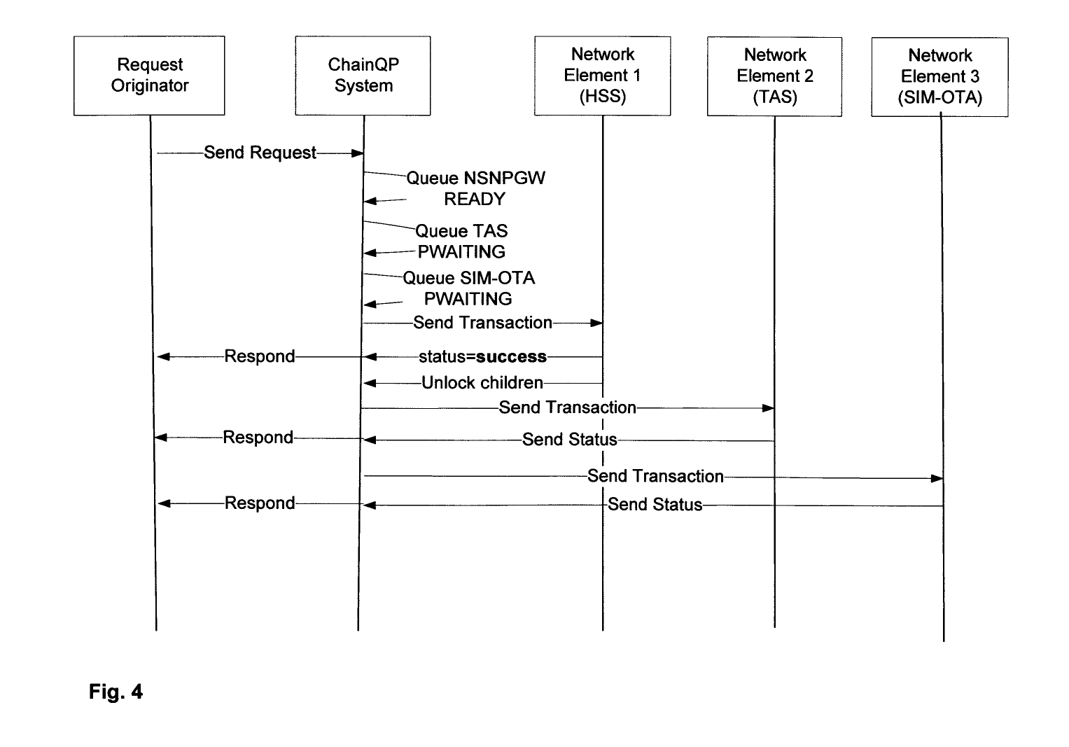

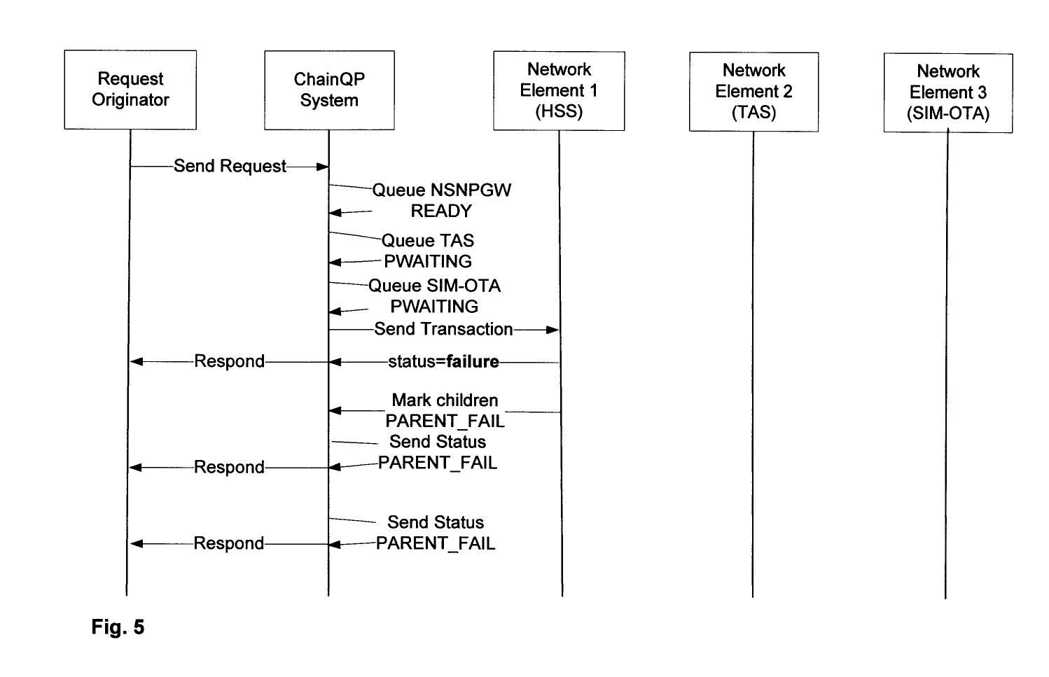

FIGS. 4 and 5 illustrate flow diagrams of chain queuing and processing where FIG. 4 illustrates a successful processing outcome and FIG. 5 illustrates a failed processing outcome. FIG. 4 begins with a requesting device 120 sending a request to a ChainQP system 130. In an exemplary embodiment, ChainQP system 130 may be incorporated into Mobile Telephony Activation System (“MTAS”). The ChainQP system 130 may then apply dispatching rules and queue three transactions associated with the request. The three transactions associated with one request illustrated in FIG. 4 are exemplary only and include a transaction to be processed at a Home Subscriber Server (“HSS”) network element, a transaction to be processed at a Telephony Application Server (“TAS”) network element, and a transaction to be processed at a SIM Over-The-Air (“SIM-OTA”) network element. In the example provided in FIG. 4, the HSS network element must process a transaction before the SIM-OTA network element may process a transaction for the same identity because in order for the SIM-OTA network element to start over-the-air programming, the subscriber should be successfully provisioned for data services at the HSS network element. Furthermore, the TAS network element, which may access and/or store subscriber information pertinent to voice parity features in HSS network element associated with the identity being provisioned. Accordingly, in this example, the HSS should successfully process its transaction before the TAS network element processes its transaction so the TAS data may be propagated into HSS for further storage and access.

Further examples of network element interdependencies may include Diameter Routing Agent/Subscriber Location Functions (“DRA/SLF”) and HSS interdependency; DRA/SLF, HSS, and Open Mobil Alliance device management (“OMA-DM”) interdependencies. In the DRA/SLF-HSS interdependency, a routing must be defined at DRA/SLF network element prior to setting up a service at HSS network element. Additionally, for self-activation, removal of self-activation from HSS network element before provisioning on-call processing network elements. An example of DRA/SLF-HSS-OMA-DM interdependencies may exist in software updates to achieve predictive software updates, where a DRA/SLF-HSS interdependency must be processed prior to provisioning at OMA-DM for Over-The-Air (“OTA”) functions such as software upgrades, loading of security data or access key data, and/or coordinating among several OTA platforms.

As illustrated in FIG. 4, the HSS transaction has a control flag set to READY and is next in queue to be processed at the first network element (HSS network element). The TAS transaction and the SIM-OTA transaction both have a control flag set to PWAITING as a result of the dispatching rules at the ChainQP system. The HSS transaction is then successfully processed at the HSS network element 140 and the response is sent to the ChainQP system 130 which evaluates a completion status and may send a message to a request originator. The completion status may include a Splitlist to be sent to the requesting device 120 to provide a complete picture of what transactions were queued based on the original request. Next, the successive transactions, those transactions associated with this request with a control flag of PWAITING, may be unlocked, and the control flag associated with each successive transaction may be changed from PWAITING to READY. Accordingly, the TAS and SIM-OTA transactions may each be processed at their respective network element. According to the flow of data in FIG. 4, the result of the transaction processing at the TAS network element 140 and the SIM-OTA network element 140 is a successful processing. Accordingly, the results may be sent to the ChainQP system 130 and a completed status and Splitlist may be sent to the requesting device 120.

In contrast, FIG. 5 presents an exemplary embodiment including a failed request processing. The process may begin with a request sent from a requesting device 120 to a ChainQP system 130. Similar to FIG. 4, the ChainQP system 130 may apply dispatching rules in order to queue the transactions associated with the request. In the example provided in FIG. 5, three transactions are associated with the request (an HSS transaction, a TAS transaction, and an SIM-OTA transaction). Specifically, in this example, the HSS transaction has a control flag set to READY and is next in queue to be processed at the first network element 140 (the HSS network element). Also in this example, the TAS transaction and the SIM-OTA transaction both have a control flag set to PWAITING as a result of the dispatching rules at the ChainQP system 130. The processing of the HSS transaction at the HSS network element 140 may result in a failure. Accordingly, a failure status may be sent from the network HSS element 140 to the ChainQP system 130. Additionally, all child transactions may be removed from the queue in which they were placed in the ChainQP system 130 and a FAILED_PARENT status may be assigned to the child transactions to indicate that the parent transaction was not successful. Finally, a completion status of failure may be sent to the requesting device 120. The process flows of FIGS. 4 and 5 are exemplary only. Other network elements, transactions, responses, and statuses may be set as necessary to properly process a request. Other network elements may include a Home Location Register (“HLR”) network element, which may include a customer information database for mobile devices that may store identity card details; a Global System for Mobile Communications (“GSM”) network element, which includes services that a subscriber has requested or been given, subscriber location data, and/or call divert settings; a Super Distributed Home Location Register (“SDHLR) network element, which may include a customer data management system that may authorize roaming, determine preferences, and be involved with billing; a Voicemail (“VM”) network element; a short message service center (“SMSC”) network element, which may store, forward, convert, and deliver SMS messages; an authentication, authorization, and account (“AAA”) network element; a ringback tone (“RBT”) network element; an Open Mobile Alliance Device Management (OMA-DM) network element, which may manage mobile devices and support provisioning, device configuration, software upgrades, and fault management; and a Subscriber Profile Controller (“SPC”) network element.

Additionally, it is to be appreciated that the set of instructions, e.g., the software, which configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system comprising:
a chain queuing and processing system comprising:
an input/output module, wherein the input/output module is configured to:
receive, via a network, at least one request for provisioning a customer device from at least one requesting device;
transmit, via the network, at least two transactions based on the received request to at least one network element; and
a chain queuing module comprising at least one processor, wherein the chain queuing module is operatively coupled with the input/output module and is configured to:
process the at least one request to determine the at least two transactions to be queued;
determine a control flag for each of the at least two transactions based on a relationship between the at least two transactions; and
determine an execution plan based on the at least two transactions to be queued and the control flag determined for each of the at least two, wherein the execution plan includes each transaction and a respective network element to process each transaction;
assign each of the at least two transactions to a network element queue associated with the network element determined in the execution plan, wherein the determined control flag indicates a queue position for each transaction.

2. The system of claim 1 wherein the relationship of the at least two transactions is a parent-child relationship and wherein the control flag of a child transaction of the at least two transactions is set to READY and wherein the control flag of at least one parent transaction of the at least two transactions is set to PWAITING.

3. The system of claim 2, wherein the input/output module is further configured to receive a transaction processed response once a transaction is processed at a network element.

4. The system of claim 3, wherein the transaction process response of the parent transaction is transaction failed, and wherein, in response to the transaction failed response, the at least one child transaction are removed from the network element queue.

5. The system of claim 4, wherein a history status for the at least one child transaction is set to reflect a failed parent transaction processing.

6. The system of claim 3, wherein the transaction process response of the parent transaction is transaction completed, and wherein, in response to the transaction completed response, the control flag of the at least one child transaction is updated to READY.

7. The system of claim 1, wherein the execution plan is based on the requesting device.

8. The system of claim 2, further comprising a third transaction and wherein the control flag of the third transaction is set to WAITING to indicate that there is a previously queues transaction in a network element transaction queue based on the request with a control flag set to READY, PROCESSING, or WAITING and there is no parent-child relationship associated with the third transaction.

9. The system of claim 1, wherein the customer device is at least one of: a mobile device, a computer, and a television.

10. The system of claim 6, wherein the control flag for every child transaction associated with the at least one parent transaction is changed from PWAITING to READY.

11. A method comprising
receiving at a chain queuing and processing system at least one request for provisioning a customer device from at least one requesting device;
processing the at least one request to determine at least two transactions to be queued in at least one network element queue;
determining a control flag for each of the at least two transactions based on a relationship between the at least two transactions;
determining an execution plan based on the at least two transactions to be queued and the control flag determined for each of the at least two, wherein the execution plan includes each transaction and a respective network element to process each transaction; and
transmitting the at least two transactions based on the received request to the at least one network element queue.

12. The method of claim 11 wherein the relationship of the at least two transactions is a parent-child relationship and wherein the control flag of a parent transaction of the at least two transactions is set to READY and wherein the control flag of at least one child transaction of the at least two transactions is set to PWAITING.

13. The method of claim 12, wherein the method further comprises receiving a transaction processed response once a transaction is processed at a network element.

14. The method of claim 13, wherein the transaction process response of the parent transaction is transaction failed, and wherein, in response to the transaction failed response, the at least one child transaction are removed from the network element queue.

15. The method of claim 14, wherein a history status for the at least one child transaction is set to reflect a failed parent transaction processing.

16. The method of claim 13, wherein the transaction process response of the parent transaction is transaction completed, and wherein, in response to the transaction completed response, the control flag of the at least one child transaction is updated to READY.

17. The method of claim 1, wherein the execution plan is based on the requesting device.

18. The method of claim 12, further comprising a third transaction and wherein the control flag of the third transaction is set to WAITING to indicate that there is a previously queues transaction in a network element transaction queue based on the request with a control flag set to READY, PROCESSING, or WAITING and there is no parent-child relationship associated with the third transaction.

19. The method of claim 11, wherein the customer device is at least one of: a mobile device, a computer, and a television.

20. The system of claim 16, wherein the control flag for every child transaction associated with the at least one parent transaction is changed from PWAITING to READY.
